(19) United States
(12) Patent Application Publication
(10) Pub. No.: US 2005/0236308 A1
(43) Pub. Date: Oct. 27, 2005

(54) Filter core controller device of water filter device

(76) Inventor: Wchen-Kang Lin, Taichung (TW)

Correspondence Address: WCHEN-KANG LIN, 235 CHUNG-HO BOX 8-24, TAIPEI HSIEN, 235, TW

(21) Appl. No.: 10/829,084

(22) Filed: Apr. 22, 2004

(51) Int. Cl. B01D 35/143

(52) U.S. Cl. 210/91; 210/85; 210/138; 96/417

(57) ABSTRACT

A filter core controller device of a water filter device comprises a chip in a filter core of the water filter device; the filter core having an erasable chip; codes and accumulating operation time period being recorded in the chip; a control unit for reading the cord in the chip so as to determining whether the filter core is a set one and reading the accumulating operation time period for determining whether the filter core is overdue and updating the accumulating operation time period in the chip. The signals of the chip and the signals of the control device are transmitted wirelessly or by wires.

### FIELD OF THE INVENTION

The present invention relates to water filter devices, and particular to a filter core controller device of a water filter device which can determine the accumulating operation time period and to determine whether the filter core is manufactured by the original manufacturer.

### BACKGROUND OF THE INVENTION

Water filter devices are currently widely used in homes or offices so as to filter impurities from the water to assure the cleanness of the water. However, the filter core will be ineffective as it is used overdue. To assure the water filter device is used in a due time, the service period of the filter core is recorded.

The prior art water filter device mainly includes a filter core and a control device. The filter core has a sensor to sense the operation of the filter core and then the operation time is transferred to the control device. Operation time is accumulated to calculate the accumulating operation time of the filter core. However, in this prior art, if the original filter core is overdue, the user places another filter core to replace the original one, but it is possible that the update filter core has been used and possible that the update filter core is not the one manufactured by another manufacturer. Maybe the filter core is a counterfeit one which has bad quality.

Thereby, there is an eager demand for a novel filter core which can be detected so as to determine the accumulating operation time period and to determine whether the filter core is manufactured by the original manufacturer.

### SUMMARY OF THE INVENTION

Accordingly, the primary object of the present invention is to provide a filter core controller device of a water filter device which can determine the accumulating operation time period and to determine whether the filter core is manufactured by the original manufacturer.

To achieve above objects, the present invention provides a filter core controller device of a water filter device which comprises a chip in a filter core of the water filter device; the filter core having an erasable chip; codes and accumulating operation time period being recorded in the chip; a control unit for reading the cord in the chip so as to determining whether the filter core is a set one and reading the accumulating operation time period for determining whether the filter core is overdue and updating the accumulating operation time period in the chip. The signals of the chip and the signals of the control device are transmitted wirelessly or by wires.

Moreover, the present invention provides a filter core controller device of a water filter device. The controller device comprises a control device for controlling operation of the water filter device; a display device for displaying an accumulating operation time period and a current operation time; a detecting device for detecting actuations and de-actuations of the water filter device; a filter core; a chip in the filter core for recording a password and an accumulating operation time period of the filter core; a timer for measuring a current operation time which is then transfereed to the control device and the chip of the filter core to be added to the accumulating operation time period. When the filter core is installed in the water filter device; the control device will read the password in the chip for determining whether the filter core is a set one. If yes, the filter core is actuated, otherwise the filter core is stopped; if the filter core is a set one, then the control device determines whether the filter core is overdue from the accumulating operation time period read from the chip.

The various objects and advantages of the present invention will be more readily understood from the following detailed description when read in conjunction with the appended drawing.

### BRIEF DESCRIPTION OF THE DRAWINGS

FIG. 1 is a structural schematic view of the present invention.

FIG. 2 shows the structure of the chip of the present invention.

FIG. 3 shows that the structure that the present invention is used in a wireless communication.

FIG. 4 shows the structure of the control unit when the present invention is used in wireless communication.

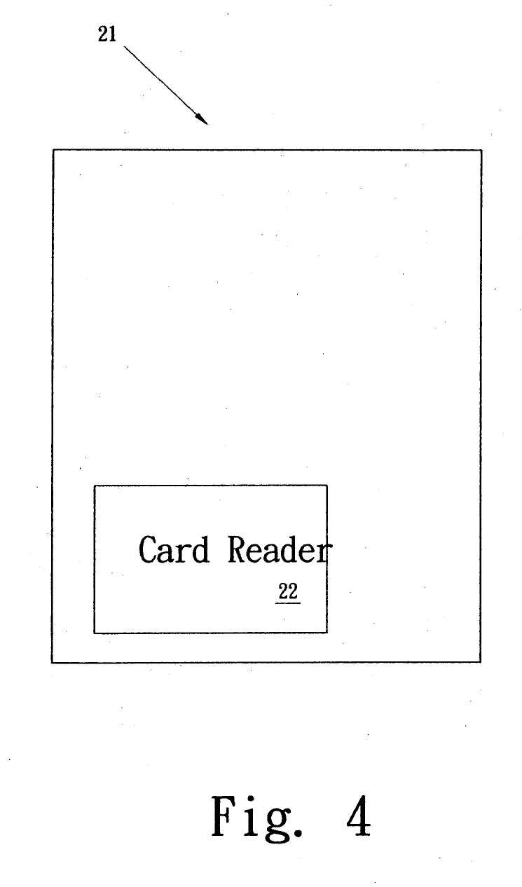

### DETAILED DESCRIPTION OF THE INVENTION

In order that those skilled in the art can further understand the present invention, a description will be described in the following in details. However, these descriptions and the appended drawings are only used to cause those skilled in the art to understand the objects, features, and characteristics of the present invention, but not to be used to confine the scope and spirit of the present invention defined in the appended claims.

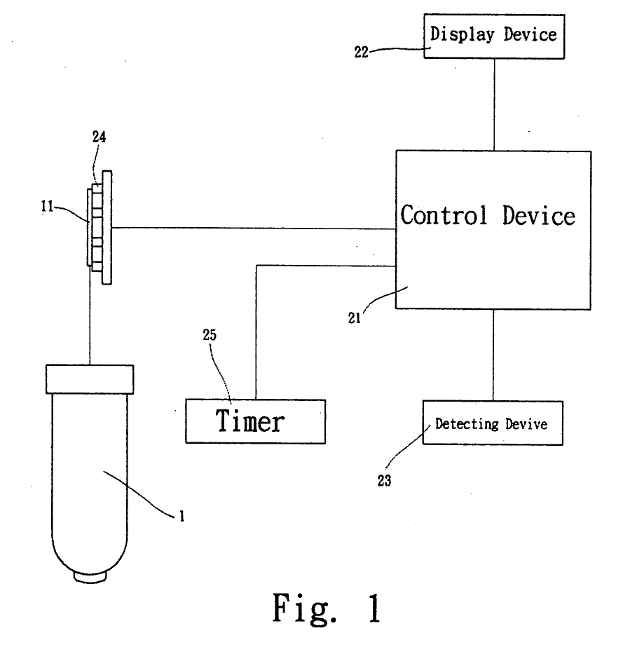

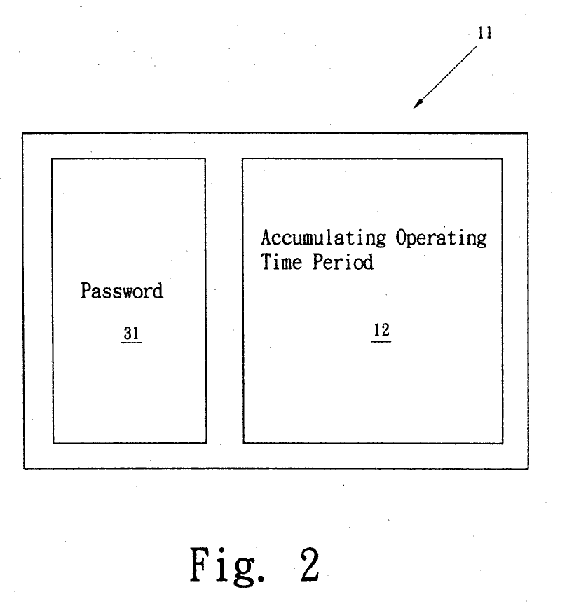

With reference to FIGS. 1 and 2, the filter core controller device of a water filter device of the present invention is illustrated. The water filter device has a control unit 21 for controlling the operation of the whole water filter device, a display device 22 for displaying the accumulating operation time period and the operation time of the water filter device; a detecting device 23 for sensing the actuation and stop of the water filter device; and a timer 25 for measuring the operation of the filter core.

The filter core 1 has a chip 11 and a joint 24. The joint 24 serves to transfer signals to the control unit 21.

The filter core 1 is has the erasable chip 11 with memory function. The chip 11 of the filter core 1 records a specific password 31 and the accumulating operation time period 12 of the filter core 1. The operation time measured by the timer 25 is transferred to the control unit 21 and the chip 11 and the chip 11 adds the operation time to the accumulating operation time period 12.

When the filter core 1 is filled intlo the water filter device, chip 11 of the filter core 1 will communicate to the joint 24. Meanwhile, when filter core 1 is installed into the water filter device. The control unit 21 of the water filter device will read the password 31 in the chip 11 and check whether the password 31 is matched to set data in the control unit 21 so as to determine whether the filter core 1 is a set one. If yes, the filtering function of the filter core 1 is actuated. Otherwise, the water filter device is stopped so as to achieve the object of counterfeit-proof.

If the filter core 1 is a set one, the control unit 21 will further read the accumulating operation time period 12 in the chip 11 to determine whether the filter core 1 is used or to determine the operation time of the filter core 1 so as to determine whether the filter core 1 is in the usable period. If not, the filter core 1, is not actuated. If yes, the filter core 1 is actuated so as to filter water flowing through the water filter device. Meanwhile, the timer 25 calculates the operation time and input the operation time into the control unit 21. The process is performed continuously so as to accumulate the accumulating operation time period 12. Thereby, the surplus operation time of the filter core 1 is determined.

Therefore, the record of the chip 11 of the filter core 1 is always retained in a new state no matter whether the filter core 1 is installed in the water filter device, even the water filter device can determine whether the filter core 1 is a set filter core so as to provide data to user to determine whether it is necessary to update the filter core 1. Moreover, the overdue filter core will not be used.

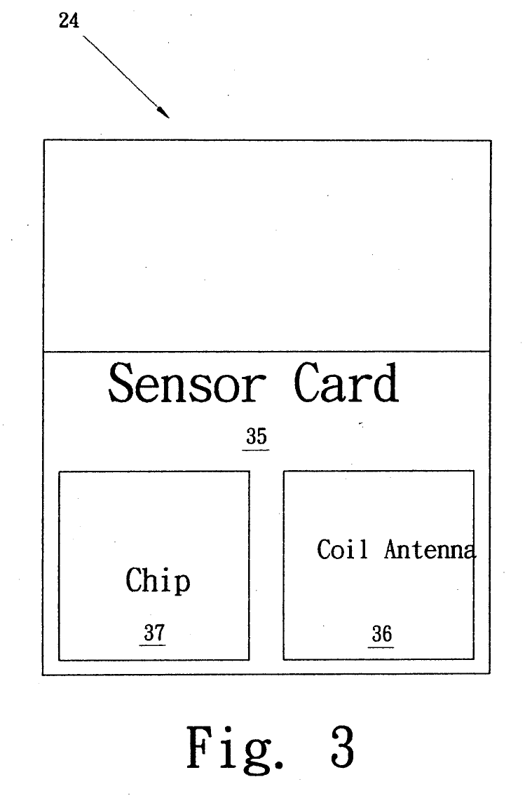

Referring to FIGS. 3 and 5, in the present invention, the signal communication between the joint 24 and the control unit 21 can be performed by wireless communication. In the wireless communication, a sensor card 35 is installed at the joint 24. The sensor card 35 is formed by a chip 37 and a coil antenna 36. A card reader 22 is installed at the control unit 21. In operation, the card reader 22 will emit radio frequency wave signals to the sensor card 35. The sensor card 35 will receive the signals from the coil antenna 36. Then power is induced by the radio frequency wave. Then the chip 37 will resend a set of special codes to the card reader 22. Thereby, the signals are communicated wirelessly.

The present invention is thus described, it will be obvious that the same may be varied in many ways. Such variations are not to be regarded as a departure from the spirit and scope of the present invention, and all such modifications as would be obvious to one skilled in the art are intended to be included within the scope of the following claims.

1. A filter core controller device of a water filter device comprising:
a chip in a filter core of the water filter device; the filter core having an erasable chip; codes and accumulating operation time period being recorded in the chip;
a control unit for reading the cord in the chip so as to determining whether the filter core is a set one and reading the accumulating operation time period for determining whether the filter core is overdue and updating the accumulating operation time period in the chip.

2. The filter core controller device of a water filter device as claimed in claim 1, wherein the signals of the chip and the signals of the control device 21 are transmitted wirelessly.

3. The filter core controller device of a water filter device as claimed in claim 1, wherein the signals of the chip and the signals of the control device are transmitted by signals wires.

4. The filter core controller device of a water filter device as claimed in claim 1, wherein a sensor card is installed at a joint connected to the chip; the sensor card has a second chip a coil antenna; a card reader is installed at the control unit; in operation, the card reader emits radio frequency wave signals to the sensor card; the sensor card receives the signals from the coil antenna; then power is induced by the radio frequency wave; then the second chip will resend a set of special codes to the card reader; thereby, the signals are communicated wirelessly.

5. A filter core controller device of a water filter device comprising:
a control device for controlling operation of the water filter device;
a display device for displaying an accumulating operation time period and a current operation time;
a detecting device for detecting actuations and de-actuations of the water filter device;
a filter core;
a chip in the filter core for recording a password and an accumulating operation time period of the filter core;
a timer for measuring a current operation time which is then transferred to the control device and the chip of the filter core to be added to the accumulating operation time period;
wherein when the filter core is installed in the water filter device; the control device will read the password in the chip for determining whether the filter core is a set one; if yes, the filter core is actuated, otherwise the filter core is stopped; if the filter core is a set one, then the control device determines whether the filter core is overdue from the accumulating operation time period read from the chip.

6. The filter core controller device of a water filter device as claimed in claim 5, wherein the signals of the chip and the signals of the control device are transmitted wirelessly.

7. The filter core controller device of a water filter device as claimed in claim 5, further comprising a joint for transferring signals of the chip to the control device by signal wires.

8. The filter core controller device of a water filter device as claimed in claim 7, wherein a sensor card is installed at a joint connected to the chip; the sensor card has a second chip a coil antenna; a card reader is installed at the control unit; in operation, the card reader emits radio frequency wave signals to the sensor card; the sensor card receives the signals from the coil antenna; then power is induced by the radio frequency wave; then the second chip will resend a set of special codes to the card reader; thereby, the signals are communicated wirelessly.
